(19) United States
(12) Patent Application Publication
(10) Pub. No.: US 2025/0299867 A1
(43) Pub. Date: Sep. 25, 2025

(54) ELECTRONIC COMPONENT AND METHOD FOR PRODUCING THE SAME

(71) Applicant: Murata Manufacturing Co., Ltd., Kyoto-fu (JP)

(72) Inventor: Masaki FUJIYAMA, Nagaokakyo-shi (JP)

(73) Assignee: Murata Manufacturing Co., Ltd., Kyoto-fu (JP)

(21) Appl. No.: 19/084,185

(22) Filed: Mar. 19, 2025

(30) Foreign Application Priority Data
Mar. 21, 2024 (JP) 2024-044845

(51) Int. Cl. H01F 27/255; H01F 27/28; H01F 41/02

(52) U.S. Cl. CPC H01F 27/255; H01F 27/28; H01F 41/0206

(57) ABSTRACT

An external conductor includes, from a component body side, at least a baked film and a plating film in contact with the baked film. The baked film contains silver and glass. Floated glass portions derived from the glass are exposed at a surface of the baked film that is in contact with the plating film, and the maximum diameter of the floated glass portions is 4.8 μm or less. The value of 4.8 μm can be used as a critical value for the maximum diameter of the floated glass portions at or below which the continuity of the plating film on the baked film can be maintained.

### CROSS-REFERENCE TO RELATED APPLICATION

This application claims benefit of priority to Japanese Patent Application No. 2024-044845, filed Mar. 21, 2024, the entire content of which is incorporated herein by reference.

### BACKGROUND

### Technical Field

The present disclosure relates to an electronic component and a method for producing the same and particularly to the structure of external conductors disposed on the outer surface of a component body and a method for producing the external conductors.

### Background Art

For example, Japanese Unexamined Patent Application Publication No. 2017-195309 describes a multilayer coil component including external conductors serving as terminal electrodes disposed on the outer surface of a component body. The external conductors each include a baked film serving as a base and containing, for example, silver and glass and nickel plating and tin plating formed on the baked film. In this multilayer coil component, the outer surface of the component body is coated with a glass layer.

It is stated in Japanese Unexamined Patent Application Publication No. 2017-195309 that it is preferable that the softening point of the glass used as a material of the baked film is lower than the softening point of the glass forming the glass layer.

### SUMMARY

As described above, with the technique described in Japanese Unexamined Patent Application Publication No. 2017-195309, it is necessary that the softening point of the glass used as a material of the baked film be somewhat low. However, when the softening point of the glass is low, the following problem may occur.

During firing for forming the baked film, the glass floats to the surface. If the softening point of the glass is low, the glass melts excessively, and the liquefied glass spreads out. Therefore, the proportion of the glass on the surface of the baked film serving as the base for plating increases, and the area of the floated glass portions that inhibit electroplating becomes large. In this case, the nickel plating film formed by plating on the baked film may become discontinuous, and the reliability of the external conductors decreases.

Accordingly, the disclosure provides an electronic component including external conductors that are disposed on the outer surface of a component body and that are configured such that a plating film can be formed in a highly continuous manner on a baked film serving as a base and to provide a method for producing the electronic component.

The present disclosure is first directed to an electronic component including a component body; an internal conductor disposed inside the component body and partially exposed at an outer surface of the body; and an external conductor disposed on the outer surface of the component body and electrically connected to the internal conductor.

The external conductor includes, from a component body side, at least a baked film and a plating film in contact with the baked film, and the baked film contains silver and glass.

In the electronic component according to the present disclosure, to solve the technical problem described above, floated glass portions derived from the glass are exposed at a surface of the baked film, the surface being in contact with the plating film, and a maximum diameter of the floated glass portions is 4.8 μm or less.

The present disclosure is also directed to a method for producing the above-described electronic component.

The method for producing the electronic component according to the present disclosure includes the step of preparing a component body including an internal conductor disposed thereinside and partially exposed at an outer surface of the component body; the step of preparing an electroconductive paste containing a silver powder and a glass powder; the step of applying the electroconductive paste to the outer surface of the component body so as to be electrically connected to the internal conductor; the step of forming a baked film by firing the electroconductive paste applied to the outer surface of the component body; and the step of subjecting the baked film to electroplating to form a plating film.

In the method for producing the electronic component according to the present disclosure, the glass powder contained in the electroconductive paste in the step of preparing the electroconductive paste contains high-softening point glass having a softening point of 720° C. to 870° C. In the step of forming the baked film, a top temperature of 730° C. to 860° C. is applied in order to sinter the electroconductive paste. A reducing atmosphere or a nitrogen atmosphere is used at least in a sintering facilitating temperature range for the silver powder that is a range of 500° C. or higher during heating to the top temperature. Floated glass portions derived from the glass powder are exposed at a surface of the baked film, the surface being to be in contact with the plating film, and a maximum diameter of the floated glass portions is 4.8 μm or less.

According to the present disclosure, a critical value for the maximum diameter of the floated glass portions exposed at the surface of the baked film is given, at or below which the continuity of the plating film on the baked film serving as the base can be maintained. Specifically, it has been found that, when the maximum diameter of the floated glass portions is limited to 4.8 μm or less, the continuity of the plating film on the baked film serving as the base is maintained and the desired reliability of the external conductor can be obtained.

### BRIEF DESCRIPTION OF THE DRAWINGS

FIG. 1 is a perspective view showing the external appearance of an electronic component in an embodiment of the present disclosure;

FIG. 2 is a cross-sectional view schematically illustrating the electronic component shown in FIG. 1;

FIG. 3 is an enlarged cross-sectional view of a portion enclosed by circle III in FIG. 2;

FIG. 4A shows the surface of a baked film in an Example of the disclosure, and FIG. 4B shows the surface of a baked film in a Comparative Example; and

FIGS. 5A to 5E show cross sections of external conductors including respective baked films produced under various conditions in Experimental Examples.

### DETAILED DESCRIPTION

Referring to FIGS. 1 to 3, an electronic component 1 in one embodiment of the present disclosure will be described. The illustrated electronic component 1 is intended to be a multilayer coil component.

The electronic component 1 includes a chip-shaped component body 2 formed of a ceramic such as Ni—Zn—Cu-based ferrite. The component body 2 has a cuboidal outer shape defined by four side faces 3, 4, 5, and 6 and two end faces 7 and 8.

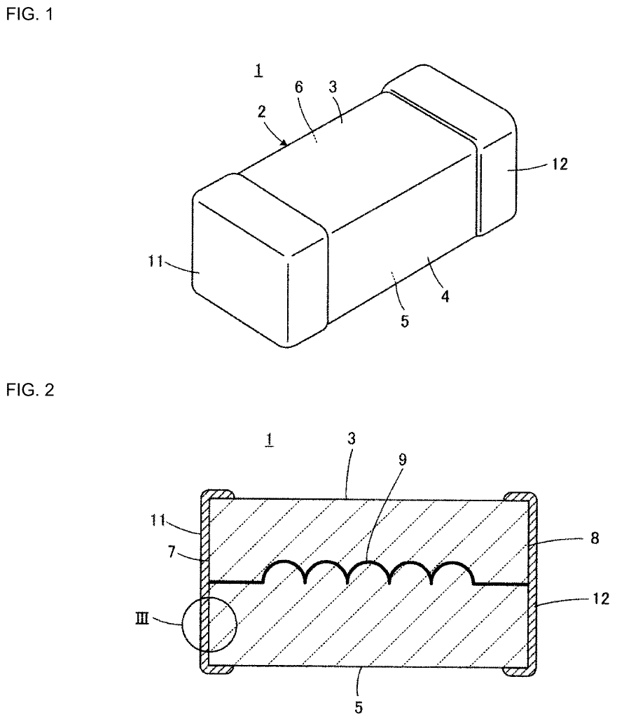

Although the details are not shown, the component body 2 has a layered structure including a plurality of ceramic layers. The stacking direction of the layered structure is freely selected and may be the left-right direction or the vertical direction in FIG. 2.

An internal conductor 9 is disposed inside the component body 2. The internal conductor 9 includes a coil conductor containing an electroconductive component such as Ag, Cu, or Pd. Therefore, although the details are not shown, the internal conductor 9 is the coil conductor. More specifically, the internal conductor 9 is a solenoid-like coil conductor as a whole including line conductors extending between ceramic layers and interlayer connection conductors connected to end portions of the line conductors and passing through the ceramic layers in the thickness direction, as is well known. The internal conductor 9 is partially exposed at the outer surface of the component body 2. In FIG. 2, the internal conductor 9 is schematically illustrated using a symbol representing a “coil.”

External conductors 11 and 12 electrically connected to the internal conductor 9 are disposed on the outer surface of the component body 2, more specifically on its end faces 7 and 8. The external conductor 11 is disposed so as to extend from the end face 7 to cover part of the side faces 3 to 6 adjacent to the end face 7, and the external conductor 12 is disposed so as to extend from the end face 8 to cover part of the side faces 3 to 6 adjacent to the end face 8.

The external conductors 11 and 12 have substantially the same cross-sectional structure. Therefore, the external conductor 11 whose cross-sectional structure is shown in an enlarged scale in FIG. 1 will be described in detail, and the description of the other external conductor 12 will be omitted.

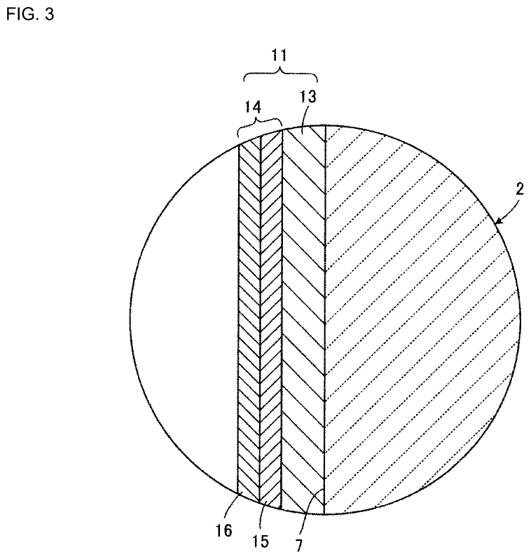

Referring to FIG. 3, the external conductor 11 includes, from the component body 2 side, at least a baked film 13 and a plating film 14 in contact with the baked film 13. The baked film 13 contains silver and glass. The plating film 14 includes, for example, a nickel plating layer 15 and a tin plating layer 16 on the nickel plating layer 15.

In brief, the following steps are performed to produce the electronic component 1. First, the component body 2 is prepared, and an electroconductive paste containing a silver powder and a glass powder is prepared. Next, the electroconductive paste is applied to the outer surface of the component body 2 so as to be electrically connected to the internal conductor 9. Next, the electroconductive paste is fired to form the baked film 13. Then electroplating is performed to form the plating film 14 on the baked film 13. In the plating step, the step of forming the nickel plating layer 15 and then the step of forming the tin plating layer 16 are performed.

The baked film 13 functions as a seed layer from which the growth of the plating starts when the electroplating for the plating film 14, particularly the electroplating for the nickel plating layer 15, is performed. It is therefore preferable that the surface of the baked film 13 that is to be in contact with the plating film 14 has good electroconductivity. However, since the baked film 13 is obtained by firing the electroconductive paste containing the silver powder and the glass powder, the baked film 13 contains silver and glass. It is therefore inevitable that floated glass portions derived from the glass are exposed at the surface of the baked film 13, i.e., the surface to be in contact with the plating film 14.

In the present disclosure, a critical value for the maximum diameter of the floated glass portions exposed at the surface of the baked film 13 is specified such that the continuity of the plating film 14 on the baked film 13 is maintained. Experimental Examples performed to determine the critical value for the maximum diameter of the floated glass portions that allows the continuity of the plating film 14 to be maintained will be described.

TABLE 1

| | | | | Maximum | |
|---|---|---|---|---|---|
| | | | | diameter | |
| | Glass grain | | | (equivalent | |
| | size | | | circle | Evaluation of |
| | distribution | Softening | Firing | diameter) | adhesion of |
| Condition | D50 (μm) | point of glass | temperature | (μm) | Ni plating |
| 1 | 1.0 | 762° C. | 800° C. | 3 | ⊚ |
| 2 | 1.0 | 762° C. | 850° C. | 3.5 | ⊚ |
| 3 | 1.0 | 762° C. | 850° C. | 4.8 | ◯ |
| 4 | 1.0 | 800° C. | 860° C. | 5 | X |
| 5 | 3.5 | 800° C. | 860° C. | 9 | X |

In the Experimental Examples, conditions 1 to 5 shown in Table 1 were applied to form baked films. In Table 1, the “Glass grain size distribution” is the grain size distribution of a glass powder contained in an electroconductive paste used to form a baked film, and the “Softening point of glass” is the softening point of the glass used as the material of the glass powder. The “Firing temperature” is the firing temperature (top temperature) applied to the electroconductive paste to form the baked film. The baked films were formed on component bodies under these conditions, and then nickel electroplating and tin electroplating were sequentially performed to form plating films. In this manner, electronic components having external conductors formed thereon and used as specimens were obtained.

The “Maximum diameter” shown in Table 1 is the maximum value of the equivalent circle diameters of floated glass portions that are two-dimensionally visible in plan view when an electronic component used as a specimen is polished from an end face to expose the baked film and the exposed surface is viewed from a direction perpendicular thereto. In the “Evaluation of adhesion of Ni plating” column in Table 1, symbols “©,” “0,” and “x” represent ratings in descending order.

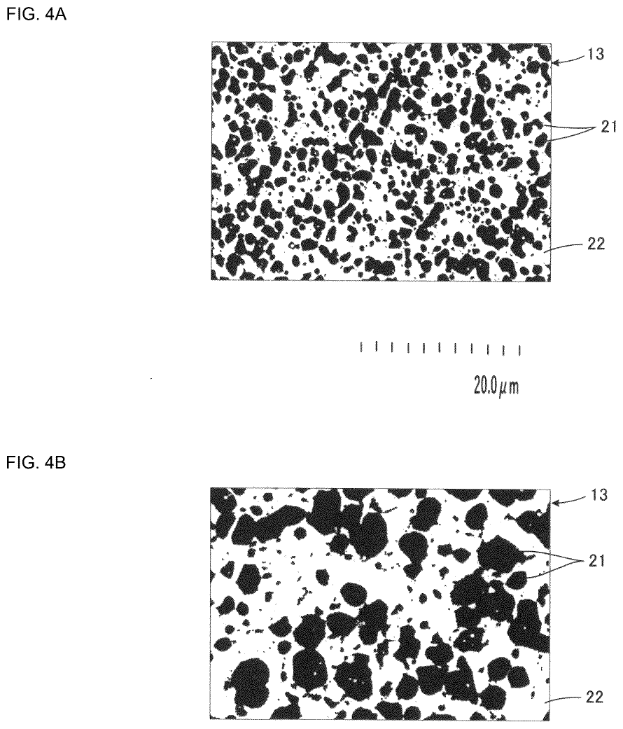

FIGS. 4A and 4B show the surfaces of baked films 13 produced in Experimental Examples. FIGS. 4A and 4B show images produced by binarizing microphotographs of the surfaces of the baked films 13. In FIGS. 4A and 4B, black spot-like regions are floated glass portions 21, and bright background regions are silver 22. FIG. 4A shows a baked film 13 in one Example of the disclosure and more specifically shows the surface of the baked film 13 produced according to condition 1 shown in Table 1. FIG. 4B shows a baked film 13 in a Comparative Example and more specifically shows the surface of the baked film 13 produced according to condition 5 shown in Table 1.

Although not clearly shown in FIG. 4A, the floated glass portions 21 in the Example tend to bulge into a substantially hemispherical shape on the surface of the baked film 13. In this state, the area of the interface with the nickel plating layer 15 can be increased, and therefore the adhesion strength of the plating film 14 to the baked film 13 can be improved.

Referring to FIGS. 4A and 4B, it can be seen that the floated glass portions 21 exposed at the baked film 13 produced under condition 1 and shown in FIG. 4A are smaller than the floated glass portions 21 exposed at the baked film 13 produced under condition 5 and shown in FIG. 4B. As shown in Table 1, the maximum diameter of the floated glass portions 21 shown in FIG. 4A is 3.0 μm, and the maximum diameter of the floated glass portions 21 shown in FIG. 4B is 9.0 μm. The maximum diameters of floated glass portions exposed at the baked films produced under conditions 1 to 5 including the baked films 13 produced under conditions 1 and 5 are as shown in Table 1.

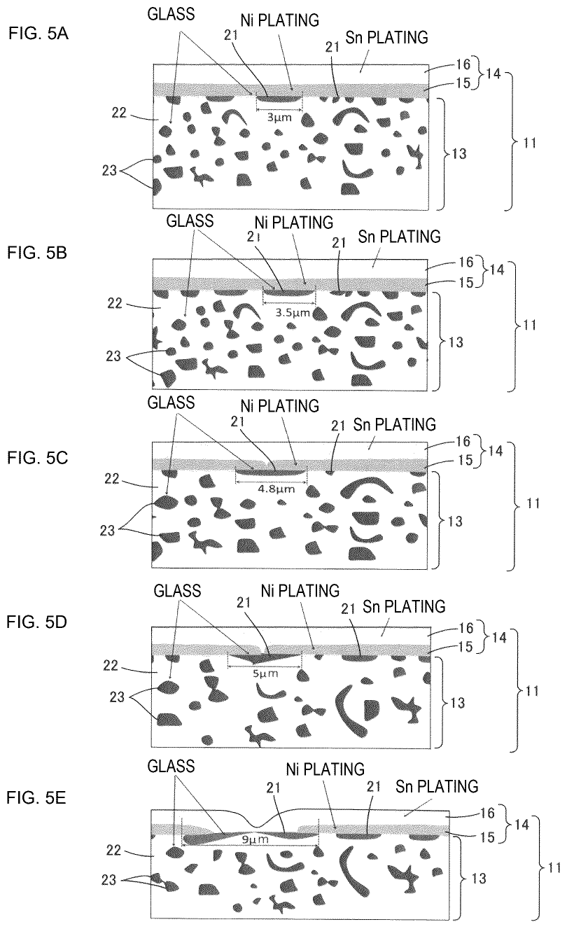

FIGS. 5A to 5E show cross sections of external conductors 11 including baked films 13 produced under various conditions in Experimental Examples. FIGS. 5A to 5E were also produced by binarizing microphotographs of cross sections of the external conductors 11 in the same manner as in FIGS. 4A and 4B. In the baked films 13 shown in FIGS. 5A to 5E, black spot-like regions are glass 23, and bright background regions are silver 22. Part of the glass 23 forms floated glass portions 21.

FIGS. 5A to 5E show the external conductors 11 including the baked films 13 produced under conditions 1 to 5, respectively, shown in Table 1.

In each cross section in FIGS. 5A to 5E, a floated glass portion 21 having the largest diameter is shown with its diameter. These maximum diameters are also shown in the “Maximum diameter” column in Table 1. In the “Evaluation of adhesion of Ni plating” column in Table 1, the morphology of the nickel plating layer 15 in contact with the floated glass portions 21 in a cross section shown in Table 5 was used for the evaluation.

The maximum diameter of the floated glass portions 21 shown in FIG. 5A is 3 μm (condition 1 in Table 1). In this situation, although the floated glass portions 21 are present, the nickel plating layer 15 fully covers the floated glass portions 21, and the thickness of the nickel plating layer 15 is substantially constant. Therefore, the result of the “Evaluation of adhesion of Ni plating” in Table 1 was “⊚.”

The maximum diameter of the floated glass portions 21 shown in FIG. 5B is 3.5 m (condition 2 in Table 1). In this situation, as in the case of condition 1, although the floated glass portions 21 are present, the nickel plating layer 15 fully covers the floated glass portions 21, and the thickness of the nickel plating layer 15 is substantially constant. Therefore, the result of the “Evaluation of adhesion of Ni plating” in Table 1 was “⊚.” This shows that, when the maximum diameter of the floated glass portions 21 is 3.5 μm or less, the floated glass portions 21 can be fully covered with the plating grown.

The maximum diameter of the floated glass portions 21 shown in FIG. 5C is 4.8 m (condition 3 in Table 1). In this situation, although not discontinuous on the floated glass portions 21, the nickel plating layer 15 is reduced in thickness on the floated glass portions 21. Therefore, the result of the “Evaluation of adhesion of Ni plating” in Table 1 was “∘.”

The maximum diameter of the floated glass portions 21 shown in FIG. 5D is 5 km (condition 4 in Table 1). In this situation, the nickel plating layer 15 is discontinuous on the floated glass portions 21. Therefore, the result of the “Evaluation of adhesion of Ni plating” in Table 1 was “x.”

The maximum diameter of the floated glass portions 21 shown in FIG. 5E is 9 km (condition 5 in Table 1). In this situation, as in the case of condition 4, the nickel plating layer 15 is discontinuous on the floated glass portions 21. Therefore, the result of the “Evaluation of adhesion of Ni plating” in Table 1 was “x.”

The above results show that the critical value is located at the maximum diameter of 4.8 μm in FIG. 5C that is smaller than the maximum diameter of 5 μm in FIG. 5D. Specifically, the critical value for the maximum diameter can be defined as 4.8 km. Therefore, in the present disclosure, the maximum diameter of the floated glass portions 21 is set to 4.8 μm or less. By comparing FIG. 5B and FIG. 5C, the maximum diameter of the floated glass portions 21 is more preferably 3.5 μm or less.

As described above, when the maximum diameter of the floated glass portions 21 is 4.8 μm or less, the nickel plating layer 15 can be formed without loss of continuity under ordinary plating conditions. In this case, the average thickness of the nickel plating layer 15 is controlled to preferably 1 μm or more and 4 μm or less (i.e., from 1 μm to 4 μm). Therefore, it is unnecessary to perform nickel plating under such conditions that the amount of plating deposited is larger than an ordinary amount, so that the nickel plating layer 15 is prevented from spreading beyond, for example, the baked film 13 into unwanted regions.

When the electronic component 1 is a coil component, the component body 2 is formed of a ceramic material such as a ferrite material. When the ferrite material contains Cu or Bi, Cu or Bi tends to precipitate at the surface of the component body 2 as a result of firing. In this case, the surface resistance of the component body 2 is lower than that of a ferrite material containing neither Cu nor Bi. Therefore, the possibility that the nickel plating layer 15 spreads beyond the baked film 13 into unwanted regions may be higher than that when a ferrite material containing neither Cu nor Bi is used. In this regard, the significance of the present disclosure is higher when the present disclosure is applied to a component body formed of a ferrite material containing Cu or Bi.

Preferred conditions for the production method in order to allow the floated glass portions 21 to have the appropriate maximum diameter described above can be found in the Experimental Examples described above. A preferred method for producing the electronic component 1 will be comprehensively described below.

The method for producing the electronic component 1 has been briefly described. First, the component body 2 is prepared, and an electroconductive paste containing a silver powder and a glass powder is prepared. In this case, the glass forming the glass powder contained in the electroconductive paste includes high-softening point glass having a softening point of preferably 720° C. or higher and 870° C. or lower (i.e., from 720° C. to 870° C.) and more preferably 750° C. or higher and 850° C. or lower (i.e., from 750° C. to 850° C.). When this high-softening point glass is included, floating of the glass to the surface of the baked film 13 can be suppressed, and the baked film 13 can be sintered at sufficiently high temperature.

However, it is preferable that the glass further includes, in addition to the high-softening point glass, low-softening point glass having a softening point of 400° C. or higher and 620° C. or lower (i.e., from 400° C. to 620° C.). When this low-softening point glass is included, the adhesion strength between the component body 2 and the baked film 13 can be increased. When the glass includes both the high-softening point glass and the low-softening point glass, the amount of the low-softening point glass is set to be smaller than the amount of the high-softening point glass. Preferably, the mixing mass ratio of the high-softening point glass to the low-softening point glass is in the range of (70 to 90):(10 to 30).

The glass powder may be a spherical powder or a flattened powder. When the glass powder is a spherical powder, its particle diameter D50 is preferably 0.5 μm or more and 1.2 μm or less (i.e., from 0.5 μm to 1.2 μm). When the glass powder is a flattened powder, its specific surface area is preferably 1.1 mm²/g or more and 6.0 mm²/g or less (i.e., from 1.1 mm²/g to 6.0 mm²/g). When the particle diameter D50 or the specific surface area is within the above range, the maximum diameter of the floated glass portions 21 can be easily adjusted to 4.8 μm or less. More preferably, D99 of the glass powder is 4.0 μm or less. When D99 is within this range, the maximum diameter of the floated glass portions 21 can be more easily adjusted to 4.8 μm or less.

Next, the electroconductive paste is applied to the outer surface of the component body 2 so as to be electrically connected to the internal conductor 9. Next, the electroconductive paste is fired, and the baked film 13 is thereby formed.

In the above-described firing step, a top temperature of 770 to 860° C. is applied in order to sinter the electroconductive paste. Then a reducing atmosphere or a nitrogen atmosphere is applied at least in a sintering facilitating temperature range for the silver powder that is a range of 500° C. or higher during heating to the top temperature. Generally, when an electroconductive paste containing a silver powder is sintered, an air atmosphere is used because there is no concern that silver will oxidize. However, the reducing atmosphere or the nitrogen atmosphere is intentionally used because it is known that the spread of the glass can be reduced. In the temperature range up to 500° C. during heating to the top temperature, it is preferable to use an air atmosphere in order to effectively burn off the binder contained in the electroconductive paste.

The floated glass portions 21 derived from the glass powder are exposed at the surface of the baked film 13 obtained by firing the electroconductive paste, i.e., at the surface to be in contact with the plating film 14, and the maximum diameter of the floated glass portions 21 is 4.8 μm or less.

The coil component has been described as an example of the electronic component that is the subject matter of the present disclosure. However, the electronic component is not limited to the coil component, and the present disclosure is applicable to other ceramic electronic components such as a multilayer ceramic capacitor and a thermistor and also to electronic components other than the ceramic electronic components.

In the illustrated embodiments, the component body has a cuboidal shape. However, the present disclosure is applicable to electronic components having shapes such as columnar and disk shapes other than the cuboidal shape.

The illustrated embodiments and some unillustrated embodiments described above are merely examples, and the structure in an embodiment may be partially replaced or combined with the structure in another embodiment.

The present disclosure includes the following embodiments.

<1> An electronic component including a component body; an internal conductor disposed inside the component body and partially exposed at an outer surface of the component body; and an external conductor disposed on the outer surface of the component body and electrically connected to the internal conductor. The external conductor includes, from a component body side, at least a baked film and a plating film in contact with the baked film. The baked film contains silver and glass. Also, floated glass portions derived from the glass are exposed at a surface of the baked film, the surface being in contact with the plating film, and a maximum diameter of the floated glass portions is 4.8 μm or less.

<2> The electronic component according to <1>, wherein the maximum diameter of the floated glass portions exposed is 3.5 μm or less.

<3> The electronic component according to <1> or <2>, wherein the glass includes high-softening point glass having a softening point of 720° C. or higher and 870° C. or lower (i.e., from 720° C. to 870° C.).

<4> The electronic component according to <3>, wherein the glass further includes, in addition to the high-softening point glass, low-softening point glass having a softening point of 400° C. or higher and 620° C. or lower (i.e., from 400° C. to 620° C.) in an amount smaller than an amount of the high-softening point glass.

<5> The electronic component according to <4>, wherein a mixing mass ratio of the high-softening point glass to the low-softening point glass is in a range of (70 to 90) (10 to 30).

<6> The electronic component according to any of <1> to <5>, wherein the floated glass portions are bulged into a substantially hemispherical shape.

<7> The electronic component according to any of <1> to <6>, wherein the plating film has an average thickness of 1 μm or more and 4 μm or less (i.e., from 1 μm to 4 μm).

<8> The electronic component according to any of <1> to <7>, wherein the electronic component is a coil component, wherein the component body is formed of a ceramic material, and wherein the internal conductor includes a coil conductor.

<9> The electronic component according to <8>, wherein the component body is formed of a ferrite material, and wherein the ferrite material contains Cu or Bi.

<10> A method for producing an electronic component, the method including the step of preparing a component body including an internal conductor disposed thereinside and partially exposed at an outer surface of the component body; the step of preparing an electroconductive paste containing a silver powder and a glass powder; the step of applying the electroconductive paste to the outer surface of the component body so as to be electrically connected to the internal conductor; the step of forming a baked film by firing the electroconductive paste applied to the outer surface of the component body; and the step of subjecting the baked film to electroplating to form a plating film. In the step of preparing the electroconductive paste, the glass powder contained in the electroconductive paste contains high-softening point glass having a softening point of 720 to 870° C. In the step of forming the baked film, a top temperature of 730 to 860° C. is applied in order to sinter the electroconductive paste, a reducing atmosphere or a nitrogen atmosphere is used at least in a sintering facilitating temperature range for the silver powder that is a range of 500° C. or higher during heating to the top temperature, floated glass portions derived from the glass powder are exposed at a surface of the baked film, the surface being to be in contact with the plating film, and a maximum diameter of the floated glass portions is 4.8 μm or less.

<11> The method for producing an electronic component according to <10>, wherein, in the step of preparing the electroconductive paste, the glass powder contained in the electroconductive paste further contains, in addition to the high-softening point glass, low-softening point glass having a softening point of 400° C. or higher and 620° C. or lower (i.e., from 400° C. to 620° C.) in an amount smaller than an amount of the high-softening point glass.

<12> The method for producing an electronic component according to <11>, wherein a mixing mass ratio of the high-softening point glass to the low-softening point glass is in a range of (70 to 90):(10 to 30).

<13> The method for producing an electronic component according to any of <10> to <12>, wherein, in the step of preparing the electroconductive paste, the glass powder contained in the electroconductive paste is at least one of a spherical glass powder or a flattened glass powder. Also, the spherical glass powder has a particle diameter D50 of 0.5 to 1.2 m, and the flattened glass powder has a specific surface area of 1.1 to 6.0 mm²/g.

<14> The method for producing an electronic component according to <13>, wherein the spherical glass powder has a particle diameter D99 of 4.0 μm or less.

What is claimed is:

1. An electronic component comprising:
a component body;
an internal conductor inside the component body and partially exposed at an outer surface of the component body; and
an external conductor on the outer surface of the component body and electrically connected to the internal conductor,
wherein
the external conductor includes, from a component body side, at least a baked film and a plating film in contact with the baked film,
the baked film includes silver and glass,
floated glass portions derived from the glass are exposed at a surface of the baked film, the surface being in contact with the plating film, and
a maximum diameter of the floated glass portions is 4.8 μm or less.

2. The electronic component according to claim 1, wherein
the maximum diameter of the floated glass portions exposed is 3.5 μm or less.

3. The electronic component according to claim 1, wherein
the glass includes high-softening point glass having a softening point of from 720° C. to 870° C.

4. The electronic component according to claim 3, wherein
the glass further includes, in addition to the high-softening point glass, low-softening point glass having a softening point of from 400° C. to 620° C. in an amount smaller than an amount of the high-softening point glass.

5. The electronic component according to claim 4, wherein
a mixing mass ratio of the high-softening point glass to the low-softening point glass is in a range of (70 to 90):(10 to 30).

6. The electronic component according to claim 1, wherein
the floated glass portions are bulged into a substantially hemispherical shape.

7. The electronic component according to claim 1, wherein
the plating film has an average thickness of from 1 μm to 4 μm.

8. The electronic component according to claim 1, wherein
the electronic component is a coil component, the component body includes a ceramic material, and the internal conductor includes a coil conductor.

9. The electronic component according to claim 8, wherein
the component body includes a ferrite material, and the ferrite material includes Cu or Bi.

10. A method for producing an electronic component, the method comprising:
preparing a component body including an internal conductor inside and partially exposed at an outer surface of the component body;
preparing an electroconductive paste including a silver powder and a glass powder;
applying the electroconductive paste to the outer surface of the component body so that the electroconductive paste is electrically connected to the internal conductor;
forming a baked film by firing the electroconductive paste applied to the outer surface of the component body; and
subjecting the baked film to electroplating to form a plating film,
wherein, in the preparing of the electroconductive paste, the glass powder in the electroconductive paste includes high-softening point glass having a softening point of 720 to 870° C., and
in the forming of the baked film,
a top temperature of 730 to 860° C. is applied to sinter the electroconductive paste,
a reducing atmosphere or a nitrogen atmosphere is used at least in a sintering facilitating temperature range for the silver powder that is a range of 500° C. or higher during heating to the top temperature,
floated glass portions derived from the glass powder are exposed at a surface of the baked film, the surface being to be in contact with the plating film, and
a maximum diameter of the floated glass portions is 4.8 μm or less.

11. The method for producing an electronic component according to claim 10, wherein
in the preparing of the electroconductive paste, the glass powder in the electroconductive paste further includes, in addition to the high-softening point glass, low-softening point glass having a softening point of from 400° C. to 620° C. in an amount smaller than an amount of the high-softening point glass.

12. The method for producing an electronic component according to claim 11, wherein
a mixing mass ratio of the high-softening point glass to the low-softening point glass is in a range of (70 to 90):(10 to 30).

13. The method for producing an electronic component according to claim 10, wherein
in the preparing of the electroconductive paste, the glass powder in the electroconductive paste is at least one of a spherical glass powder or a flattened glass powder,
the spherical glass powder has a particle diameter D50 of 0.5 to 1.2 μm, and
the flattened glass powder has a specific surface area of 1.1 to 6.0 mm²/g.

14. The method for producing an electronic component according to claim 13, wherein
the spherical glass powder has a particle diameter D99 of 4.0 μm or less.
